(19) United States
(12) Patent Application Publication
(10) Pub. No.: US 2012/0219354 A1
(43) Pub. Date: Aug. 30, 2012

(54) Cup-lock coupler clamp for detachably attaching at any elevation on a vertical tube of the cup-lock scaffold system

(76) Inventors: Ryan E. Bauer, Terre Haute, IN (US); Herbert H. Wheeler, Terre Haute, IN (US); Leroy E. Kelsheimer, Blandford, IN (US)

(21) Appl. No.: 12/932,374

(22) Filed: Feb. 24, 2011

(51) Int. Cl. E04G 7/12; F16B 7/04

(52) U.S. Cl. 403/187

(57) ABSTRACT

A coupler clamp for detachably attaching at least one horizontal tube of a cup-lock scaffold system to any elevation of a vertical tube of the cup-lock scaffold system. The clamp includes a first jaw and a second jaw. The first jaw is hinged to the second jaw for allowing the coupler clamp to wrap around the vertical tube of the cup-lock scaffold system and capture an associated flanged end of each of the at least one horizontal tube of the cup-lock scaffold system so as to allow the coupler clamp to detachably attach the at least one horizontal tube of the cup-lock scaffold system to any elevation of the vertical tube of the cup-lock scaffold system.

### 1. BACKGROUND OF THE INVENTION

A. Field of the Invention

The embodiments of the present invention relate to a cup-lock scaffold coupler, and more particularly, the embodiments of the present invention relate to a coupler clamp for detachably attaching at least one horizontal tube of a cup-lock scaffold system to any elevation of a vertical tube of the cup-lock scaffold system.

B. Description of the Prior Art A typical prior art cup-lock scaffolding system 20 can best be seen in FIGS. 1 and 2, which are, respectively, a diagrammatic perspective view of a typical prior art cup-lock scaffolding system, and an enlarged diagrammatic perspective view of the area generally enclosed by a dotted curve identified by ARROW in FIG. 1 of a typical prior art cup-lock joint of the typical prior art cup-lock scaffolding system shown in FIG. 1, and as such, will be discussed with reference thereto.

As shown in FIG. 1, the typical prior art cup-lock scaffolding system 20 comprises a plurality of vertical tubes 22, a plurality of horizontal tubes 24, and a plurality of cup-lock couplers 26. The plurality of cup-lock couplers 26 of the typical prior art cup-lock scaffolding system 20 attach the plurality of horizontal tubes 24 of the typical prior art cup-lock scaffolding system 20 to the plurality of vertical tubes 22 of the typical prior art cup-lock scaffolding system 20 in an orthogonal arrangement.

Each vertical tube 22 of the typical prior art cup-lock scaffolding system 20 has flange cups 28 and tabs 30 fixedly attached thereto at predetermined elevations therealong. The flange cups 28 of the typical prior art cup-lock scaffolding system 20 and the tabs 30 of the typical prior art cup-lock scaffolding system 20 cooperate with associated cup-lock couplers 26 of the typical prior art cup-lock scaffolding system 20 to attach the plurality of horizontal tubes 24 of the typical prior art cup-lock scaffolding system 20 to the plurality of vertical tubes 22 of the typical prior art cup-lock scaffolding system 20 in the orthogonal arrangement.

Being that the flange cups 28 of the typical prior art cup-lock scaffolding system 20 and the radial tabs 30 of the typical prior art cup-lock scaffolding system 20 are fixed at predetermined elevations along each vertical member 22 of the typical prior art cup-lock scaffolding system 20, the horizontal members 24 of the typical prior art cup-lock scaffolding system 20 are limited in their placement along the vertical members 22 of the typical prior art cup-lock scaffolding system 20 to only where there are the flange cups 28 of the typical prior art cup-lock scaffolding system 20 and the radial tabs 30 of the typical prior art cup-lock scaffolding system 20.

The importance of the flange cup 28 of the typical prior art cup-lock scaffolding system 20 and the radial tab 30 of the typical prior art cup-lock scaffolding system 20 and their cooperation with an associated cup-lock coupler 26 of the typical prior art cup-lock scaffolding system 20 can best be seen in FIG. 2, and as such, will be discussed with reference thereto.

Each horizontal tube 24 of the typical prior art cup-lock scaffolding system 20 has flanged ends 32. Each flanged end 32 of each horizontal tube 24 of the typical prior art cup-lock scaffolding system 20 has a lower portion 34 and an upper portion 36.

The flanged end 32 of the horizontal tube 24 of the typical prior art cup-lock scaffolding system 20 is positioned against the vertical tube 22 of the typical prior art cup-lock scaffolding system 20, with the lower portion 34 of the flanged end 32 of the horizontal tube 24 of the typical prior art cup-lock scaffolding system 20 sitting in an associated flange cup 28 of the typical prior art cup-lock scaffolding system 20.

A collar 38 having a ramped top 40 and an internal cyst 42 is slipped down on the vertical tube 22 of the typical prior art cup-lock scaffolding system 20, with the cyst 42 of the collar 38 of the typical prior art cup-lock scaffolding system 20 allowing passage therethrough of the tab 30 of the vertical tube 22 of the typical prior art cup-lock scaffolding system 20, until the collar 38 of the typical prior art cup-lock scaffolding system 20 receives the upper portion 36 of the flanged end 32 of the horizontal tube 24 of the typical prior art cup-lock scaffolding system 20. The collar 38 of the typical prior art cup-lock scaffolding system 20 is rotated, with the tab 30 of the vertical tube 22 of the typical prior art cup-lock scaffolding system 20 riding along the ramped top 40 of the collar 38 of the typical prior art cup-lock scaffolding system 20 until the collar 38 of the typical prior art cup-lock scaffolding system 20 is tight against the tab 30 of the vertical tube 22 of the typical prior art cup-lock scaffolding system 20, thereby attaching the horizontal tube 24 of the typical prior art cup-lock scaffolding system 20 to the vertical tube 22 of the typical prior art cup-lock scaffolding system 20 in the orthogonal arrangement.

Numerous innovations for scaffold couplers have been provided in the prior art, which will be described below in chronological order to show advancement in the art, and which are incorporated herein by reference thereto. Even though these innovations may be suitable for the specific individual purposes to which they address, however, they differ from the present invention in that they do not teach a coupler clamp for detachably attaching at least one horizontal tube of a cup-lock scaffold system to any elevation of a vertical tube of the cup-lock scaffold system.

(1) U.S. Pat. No. 2,024,527 to Kaplan.

U.S. Pat. No. 2,024,527 issued to Kaplan on Dec. 17, 1935 in U.S. class 189 and subclass 36 teaches a coupling for the meeting ends of standards designed to be aligned in abutting relation. The coupling includes a sleeve freely movable longitudinally in both directions on the standards relative to the abutting ends. The sleeve has a bore extending vertically therethrough with one part of the wall of the bore concentrio with the outer surfaces of the standards and in contact throughout with the standards when the coupling is applied. The remaining portion of the bore forming a line continuation of the concentric portion with its margin spaced at all points from the surface of the standards with such spacing gradually decreasing downwardly to thereby provide a wedge-receiving space of a transverse dimension to permit the ends of the standards to be moved thereinto for convenience in assembling. A wedge-shaped element is arranged in the wedge-shaped portion of the bore beyond the standards. The element has an inner curved surface to accurately conform to and engage the exterior surface of the abutting ends of the standards through approximately one-half the circumferential length of the standards. The outer surface of the wedge-shaped element conforms to the inclined surface of the wedge-shaped portion of the bore for wedging purposes, whereby in applied position the abutting ends of the standards are engaged throughout, substantially one-half their circumferential lengths by the wall of the bore and engaged throughout substantially the remaining one-half of their circumferential lengths by the inner surface of the wedge-shaped element.

(2) U.S. Pat. No. 3,554,583 to Lowe.

U.S. Pat. No. 3,554,583 issued to Lowe on Jan. 12, 1971 in U.S. class 287 and subclass 53.5 teaches apparatus connecting two similarly cylindrical-shaped metal scaffold tubes in end-to-end relationship. The apparatus includes a coupler embodying a body formed of spring steel strip of surface hardness greater than the surface hardness of the metal forming the two scaffold tubes. The body includes a part circular substantially C-shaped portion embodying first and second arms, each of part circular shape on the inner face thereof. Each arm terminates in relatively diverging edge flanges. A pair of clamping bolts are spaced relatively apart in a direction along the axis of curvature of the C-shaped body and each extend through a pair of holes formed in the arms at the junction between each of the two arms and their respective edge flanges. The first arm has an internal radius of curvature corresponding to the peripheral radius of curvature of each of the two scaffold tubes so as to be in close contact therewith over the entire length of the first arm. The second arm has an internal radius of curvature greater than the peripheral radius of curvature of the two tubes so as to be spaced therefrom by a progressively increasing distance in a direction along the length of the second arm towards the associated edge flange. The second arm at that edge of each of the holes therein which is furthest from the associated edge flange has the spring metal thereof formed with an integral projection extending inwardly beyond the adjacent part circular inner face of the second arm. Each clamping bolt has a pressure applying portion embodying a peripheral edge in pressure engagement with the outer face of the second arm at a position which is directly opposite to that of one of the projections on the second arm. Each of the projections has a sharp edge in surface indenting engagement with the periphery of the adjacent scaffold tubes, with the adjacent part circular inner face of the second arm spaced out of contact with each of the two tubes.

(3) U.S. Pat. No. 3,810,704 to Lowe.

U.S. Pat. No. 3,810,704 issued to Lowe on May 14, 1974 in U.S. class 403 and subclass 385 teaches a coupler for connecting a pair of round scaffold tubes, which embodies hinged tube clamping jaws having limited opening movement, but exceeding 90° so as to allow lateral initial positioning of the scaffold tube passed the clamping bolt.

(4) U.S. Pat. No. 4,077,730 to Zaidan.

U.S. Pat. No. 4,077,730 issued to Zaidan on Mar. 7, 1978 in U.S. class 403 and subclass 385 teaches a coupling for connecting two scaffolding members. A central link is provided with two pairs of arms, each projecting from the link. Each arm is provided with an aperture. Each pair of arms are adapted to embrace a respective scaffolding member. A respective wedge is adapted to project through the apertures in a respective pair of arms so as to bear upon and retain in position an embraced scaffolding member. Each wedge is provided with a pair of stop members that serve to resist withdrawal of the wedge from the apertures.

(5) U.S. Pat. No. 4,248,544 to McKane.

U.S. Pat. No. 4,248,544 issued to McKane on Feb. 3, 1981 in U.S. class 403 and subclass 49 teaches a coupling for tubular scaffolding, which includes a boss mounted on a standard by a pin or by welding, and a wedge ring rotatably encircling and co-planar with the boss. Radial insets in the boss combine with the ring to form apertures in which pegs are located. The pegs are attached to the ends of ledgers and transoms. The inner face of the wedge ring has sloping wedge surfaces in the vicinity of the apertures, which alter the radial dimension of the apertures. Thus, when a peg is located in an aperture, the wedge ring can be rotated to wedge the peg firmly in the aperture. The problem of existing prior art is the difficulty of securing ledgers and transoms. This has to be done by screw couplings or by getting above the coupling in order to tighten it. The coupling can be operated from below, i.e., by a person standing on erected scaffolding.

(6) U.S. Pat. No. 4,369,859 to Smits.

U.S. Pat. No. 4,369,859 issued to Smits on Jan. 25, 1983 in U.S. class 182 and subclass 186.8 teaches a scaffolding system in which an upright tube is provided with an annular dish-shaped protrusion. A housing on the end of a horizontal tube carries a lever with a cam face that engages the protrusion to lock the tubes together. The horizontal tube can be at any radial orientation relative to the upright tube.

(7) U.S. Pat. No. 4,408,922 to D'Alessio.

U.S. Pat. No. 4,408,922 issued to D'Alessio on Oct. 11, 1983 in U.S. class 403 and subclass 12 teaches a coupler for joining tubing to a shoring leg or the like, which has a T-shaped bolt slot extending along the length of the leg, and which is formed of a sickle-shaped metal strap or extrusion having a C-shaped central portion, a radial extension portion at one end, and a tangential T-portion at the other end. The T-portion is formed of a head and a relatively narrow neck with adjacent opposing shoulders, and a T-bolt secured through a hole in the extension portion. The head and shoulders defining the neck of the T-portion are spaced and shaped so as readily to accommodate therebetween the lips forming of the T-slot when the T-portion is inserted generally perpendicularly into the T-slot and yet grippingly bite into the lips when the coupler falls into the cocked open position. This permits the coupler provisionally to cradle and hold the tubing in place before the T-bolt is fastened. Advantageously, the coupler is hinged between the C-portion and the T-portion, thereby assuring that the T-portion continuously grips against vertical movement in the vertically disposed T-slot even during fastening of the T-bolt.

(8) U.S. Pat. No. 5,056,954 to Flux et al.

U.S. Pat. No. 5,056,954 issued to Flux et al. on Oct. 15, 1991 in U.S. class 403 and subclass 330 teaches a releasable gripping or locking device having a body part for sliding cooperation with a rope to be releasably gripped or locked with respect to the body part. A gripping or locking member is movably mounted on the body part for movement between a free condition and a gripping or locking condition in which loading applied to the device is borne by the gripping or looking member. A control member is provided for controlling movement of the gripping or locking position. The control member includes telescoping components having interengageable latching elements that are actuated by relative movement between the device and the rope. The latching elements are adapted to be automatically engaged in a latched condition when these parts are moved relative to one another in a first direction by a predetermined amount and are brought automatically into an unlatched condition on a predetermined amount of relative movement therebetween from the latched condition in the first direction, thereby allowing subsequent free relative movement of the telescoping components. The free and gripping or locking conditions of the gripping or locking member correspond respectively with the latched and unlatched conditions of the control member.

(9) U.S. Pat. No. 5,259,690 to Legge.

U.S. Pat. No. 5,259,690 issued to Legge on Nov. 9, 1993 in U.S. class 403 and subclass 385 teaches a scaffold coupler actuated by an over-center lever mechanism. The scaffold coupler is of resilient plastics and includes a hand lever that is hinged to a jaw that closes upon a base member to clamp tight a scaffolding tube. A hook member hinged to the lever engages with a lip of the member so that depression of the lever urges the jaw hard onto the tube and actuates the clamping mechanism by pulling the hook-hinge through “over-center” alignment with the lever-jaw hinge and the hook-lip engagement “hinge.” The base-jaw surface subtends more than 180° to snap fit with the tube. Opening of the closure jaw is limited by a projection for support of the tube. Closing of the jaw may be tripped by entry of the tube. The jaws may be abrasive-surfaced to improve grip. The lever may be selectively locked in the actuated condition, and other configurations of over-center lever mechanism are possible. Right-angle, swivel, and sleeve couplers include two over-center mechanisms, whereas a putlog coupler includes one, with the second pair of jaws actuated by one or more levers that bear on the tube clamped by the first pair.

(10) U.S. Pat. No. 6,168,345 to Legge.

U.S. Pat. No. 6,168,345 issued to Legge on Jan. 2, 2001 in U.S. class 403 and subclass 385 teaches a right-angle scaffold coupler including two jaw assemblies. Each jaw assembly has jaws formed by a closure-plate hinged to a common chassis and has a hand lever hinged to the plate with a spirally-coiled spring as a hinge-pin within interleaved finger-lugs. A hook-member hinged to the lever engages a lip of the chassis so that depression of the lever pulls the plate towards the chassis in closing the jaws onto a scaffolding tube and clamping to it by over-center action. The spring coils up more tightly during the over-center action allowing resilient displacement between the lugs of hinge to accommodate variations in tube circumference. The jaw surface of the chassis subtends more than 180° to snap fit with the tube.

It is apparent that numerous innovations for scaffold couplers have been provided in the prior art that are adapted to be used. Furthermore, even though these innovations may be suitable for the specific individual purposes to which they address, however, they would not be suitable for the purposes of the embodiments of the present invention as heretofore described, namely, a coupler clamp for detachably attaching at least one horizontal tube of a cup-lock scaffold system to any elevation of a vertical tube of the cup-lock scaffold system.

### 2. SUMMARY OF THE INVENTION

Thus, an object of the embodiments of the present invention is to provide a coupler clamp for detachably attaching at least one horizontal tube of a cup-lock scaffold system to any elevation of a vertical tube of the cup-lock scaffold system, which avoids the disadvantages of the prior art.

Briefly stated, another object of the embodiments of the present invention is to provide a coupler clamp for detachably attaching at least one horizontal tube of a cup-lock scaffold system to any elevation of a vertical tube of the cup-lock scaffold system. The clamp includes a first jaw and a second jaw. The first jaw is hinged to the second jaw for allowing the coupler clamp to wrap around the vertical tube of the cup-lock scaffold system and capture an associated flanged end of each of the at least one horizontal tube of the cup-lock scaffold system so as to allow the coupler clamp to detachably attach the at least one horizontal tube of the cup-lock scaffold system to any elevation of the vertical tube of the cup-lock scaffold system.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### 3. BRIEF DESCRIPTION OF THE DRAWING

The figures of the drawing are briefly described as follows:

FIG. 1 is a diagrammatic perspective view of a typical prior art cup-lock scaffolding system;

FIG. 2 is an enlarged diagrammatic perspective view of the area generally enclosed by a dotted curve identified by ARROW in FIG. 1 of a typical prior art cup-lock joint of the typical prior art cup-lock scaffolding system shown in FIG. 1;

FIG. 3 is a diagrammatic perspective view of the coupler clamp of the embodiments of the present invention detachably attaching at least one horizontal tube of a cup-lock scaffold system to any elevation of a vertical tube of the cup-lock scaffold system;

FIG. 4 is an enlarged diagrammatic perspective view of the coupler clamp of the embodiments of the present invention identified by ARROW 4 in FIG. 3 but in the open position;

FIG. 5 is a reduced exploded perspective view of the coupler clamp of the embodiments of the present invention identified by ARROW 5 in FIG. 4;

FIG. 6 is an enlarged diagrammatic top plan view taken generally in the direction of ARROW 6 in FIG. 5;

FIG. 7 is an enlarged diagrammatic side elevational view taken generally in the direction of ARROW 7 in FIG. 5;

FIG. 8 is an enlarged diagrammatic bottom plan view taken generally in the direction of ARROW 8 in FIG. 5;

FIG. 9 is an enlarged diagrammatic top plan view taken generally in the direction of ARROW 9 in FIG. 5;

FIG. 10 is an enlarged diagrammatic side elevational view taken generally in the direction of ARROW 10 in FIG. 5;

FIG. 11 is an enlarged diagrammatic bottom plan view taken generally in the direction of ARROW 11 in FIG. 5;

FIG. 12 is a diagrammatic cross sectional view taken along LINE 12-12 in FIG. 9; and

FIG. 13 is a diagrammatic cross sectional view taken along LINE 13-13 in FIG. 6.

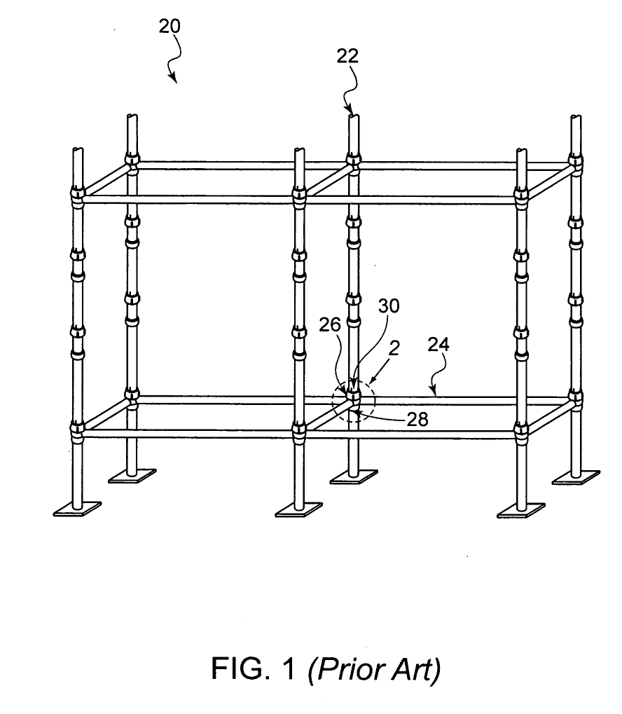

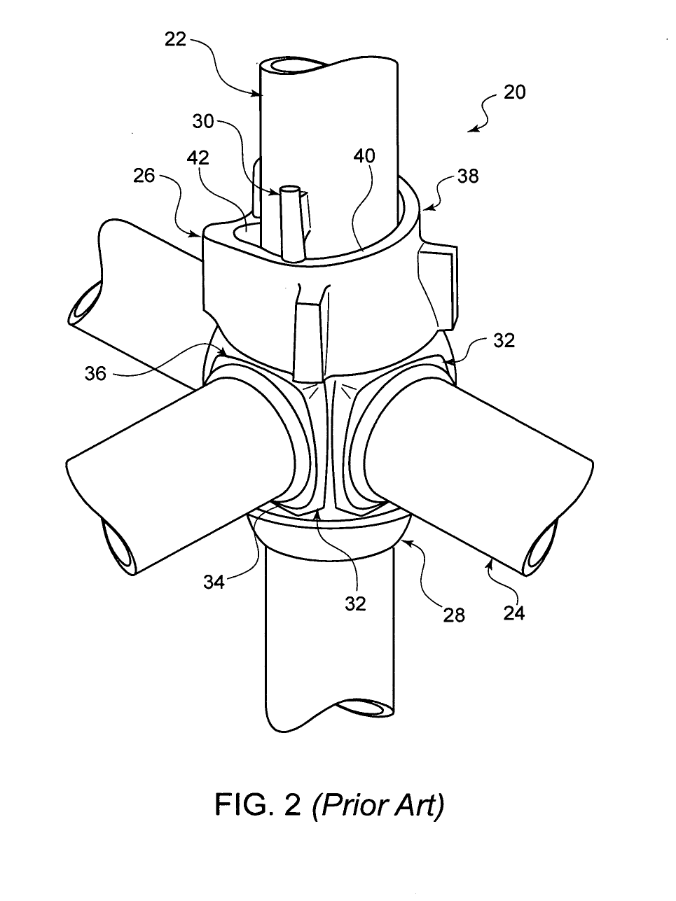

### 4. LIST OF REFERENCE NUMERALS UTILIZED IN THE FIGURES OF THE DRAWING

### A. Prior Art.

20 typical prior art cup-lock scaffolding system
22 plurality of vertical tubes of typical prior art cup-lock scaffolding system 20
24 plurality of horizontal tubes of typical prior art cup-lock scaffolding system 20
26 plurality of cup-lock couplers of typical prior art cup-lock scaffolding system 20
28 flange cups of each vertical tube of plurality of vertical tubes 22 of typical prior art cup-lock scaffolding system 20
30 radial tabs of each vertical tube of plurality of vertical tubes 22 of typical prior art cup-lock scaffolding system 20
32 flanged ends of each horizontal tube of plurality of horizontal tubes 24 of typical prior art cup-lock scaffolding system 20
34 lower portion of each flanged end of flanged ends 32 of each horizontal tube of plurality of horizontal tubes 24 of typical prior art cup-lock scaffolding system 20
36 upper portion of each flanged end of flanged ends 32 of each horizontal tube of plurality of horizontal tubes 24 of typical prior art cup-lock scaffolding system 20
38 collar of typical prior art cup-lock scaffolding system 20
40 ramped top of collar 38 of typical prior art cup-lock scaffolding system 20
42 internal cyst of collar 38 of typical prior art cup-lock scaffolding system 20

### B. General.

50 coupler clamp of embodiments of present invention for detachably attaching at least one horizontal tube 52 of cup-lock scaffold system 56 to any elevation of vertical tube 54 of cup-lock scaffold system 56
52 at least one horizontal tube of cup-lock scaffold system 56
54 vertical tube of cup-lock scaffold system 56
56 cup-lock scaffold system

### C. Configuration of Coupler Clamp 50.

58 first jaw
60 second jaw
62 flanged end of each horizontal tube of at least one horizontal tube 52 of cup-lock scaffold system 56
64 clamping bolt assembly

### (1) First Jaw 58.

66 base portion of first jaw 58
68 body portion of first jaw 58
70 hinged side portion of first jaw 58
72 free side portion of first jaw 58
74 semi-cup of base portion 66 of first jaw 58 for receiving portion of flanged ends 62 of at least one horizontal tube 52 of cup-lock scaffold system 56
76 semi-cylinder of body portion 68 of first jaw 58 for bearing upon vertical tube 54 of cup-lock scaffold system 56
78 interior surface of semi-cylinder 76 of body portion 68 of first jaw 58
80 semi-circular rings of interior surface 78 of semi-cylinder 76 of body portion 68 of first jaw 58 for improving bearing upon vertical tube 54 of cup-lock scaffold system 56
82 pair of hinge leaf knuckles of hinged side portion 70 of first jaw 58
84 one side of semi-cylinder 76 of body portion 68 of first jaw 58
86 pivot pin through bores in pair of hinge leaf knuckles 82 of hinged side portion 70 of first jaw 58, respectively
88 catch of free side portion 72 of first jaw 58
90 other side of semi-cylinder 76 of body portion 68 of first jaw 58

### (2) Second Jaw 60.

92 base portion of second jaw 60
94 body portion of second jaw 60
96 hinged side portion of second jaw 60
98 free side portion of second jaw 60
100 semi-cup of base portion 92 of second jaw 60 for receiving remaining portion of flanged ends 62 of at least one horizontal tube 52 of cup-lock scaffold system 56
102 semi-cylinder of body portion 94 of second jaw 60 for bearing upon vertical tube 54 of cup-lock scaffold system 56
104 interior surface of semi-cylinder 102 of body portion 94 of second jaw 60
106 semi-circular rings of interior surface 104 of semi-cylinder 102 of body portion 94 of second jaw 60 for improving bearing upon vertical tube 54 of cup-lock scaffold system 56
108 hinge leaf knuckle of hinged side portion 96 of second jaw 60
110 one side of semi-cylinder 102 of body portion 94 of second jaw 60
112 pivot pin through bore in hinge leaf knuckle 108 of hinged side portion 96 of second jaw 60
114 pair of catches of free side portion 98 of second jaw 60
116 other side of semi-cylinder 102 of body portion 94 of second jaw 60
118 clamp bolt pin through bores in pair of catches 114 of free side portion 98 of second jaw 60
120 hinge pin

### (3) Clamping Bolt Assembly 64.

122 bolt of clamping bolt assembly 64
124 pivot pin of clamping bolt assembly 64
126 head of bolt 122 of clamping bolt assembly 64
128 through bore in head 126 of bolt 122 of clamping bolt assembly 64
130 washer nut of clamping bolt assembly 64

### 5. DETAILED DESCRIPTION OF THE PREFERRED EMBODIMENTS

### A. General.

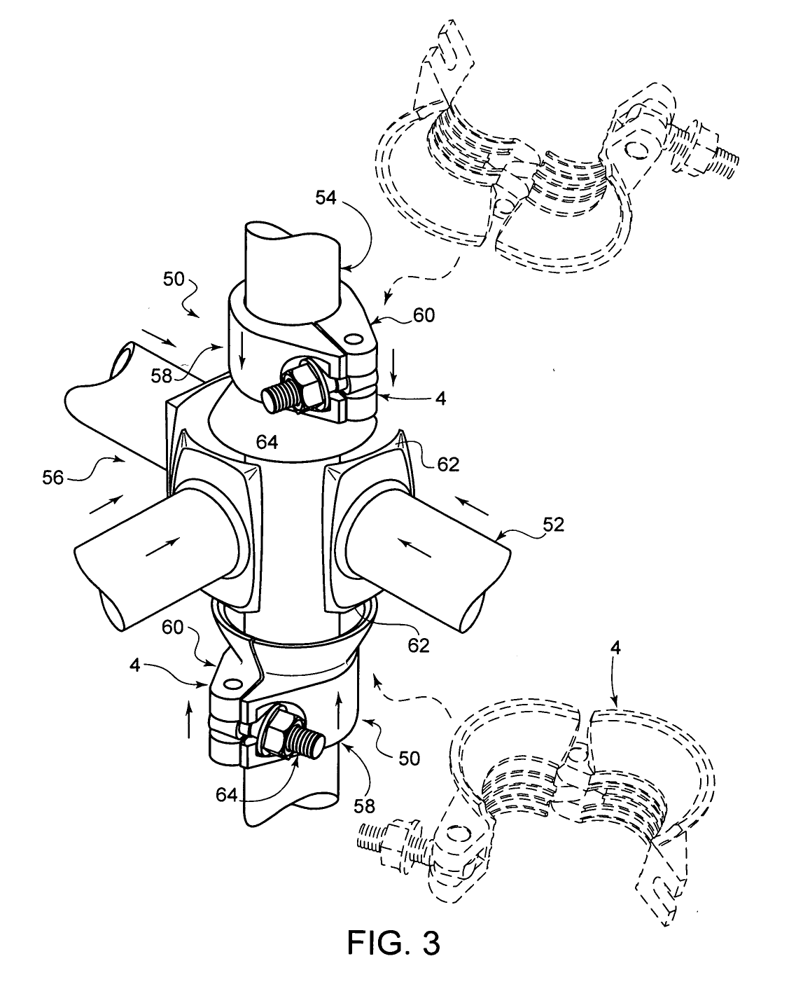

Referring now to FIG. 3, which is a diagrammatic perspective view of the coupler clamp of the embodiments of the present invention detachably attaching at least one horizontal tube of a cup-lock scaffold system to any elevation of a vertical tube of the cup-lock scaffold system, the coupler clamp of the embodiments of the present invention is shown generally at 50 for detachably attaching at least one horizontal tube 52 of a cup-lock scaffold system 56 to any elevation of a vertical tube 54 of the cup-lock scaffold system 56.

### B. Configuration of the Coupler Clamp 50.

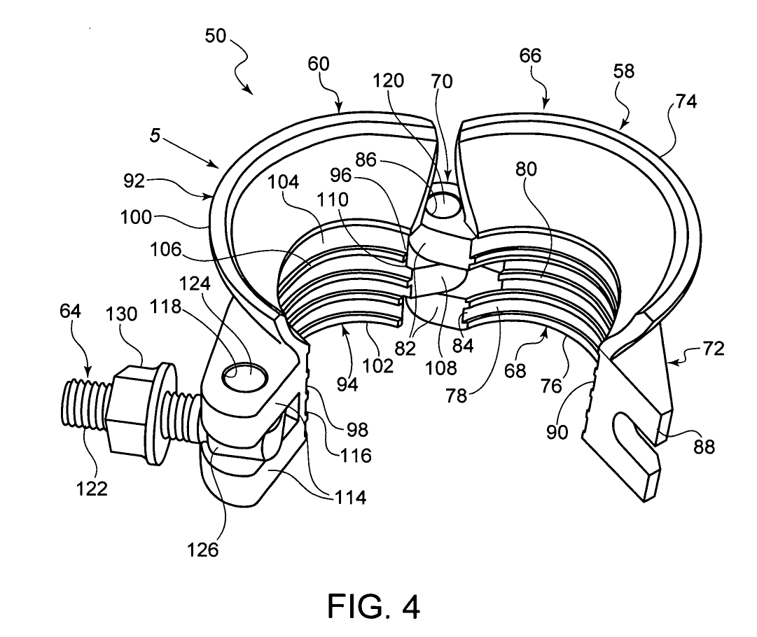

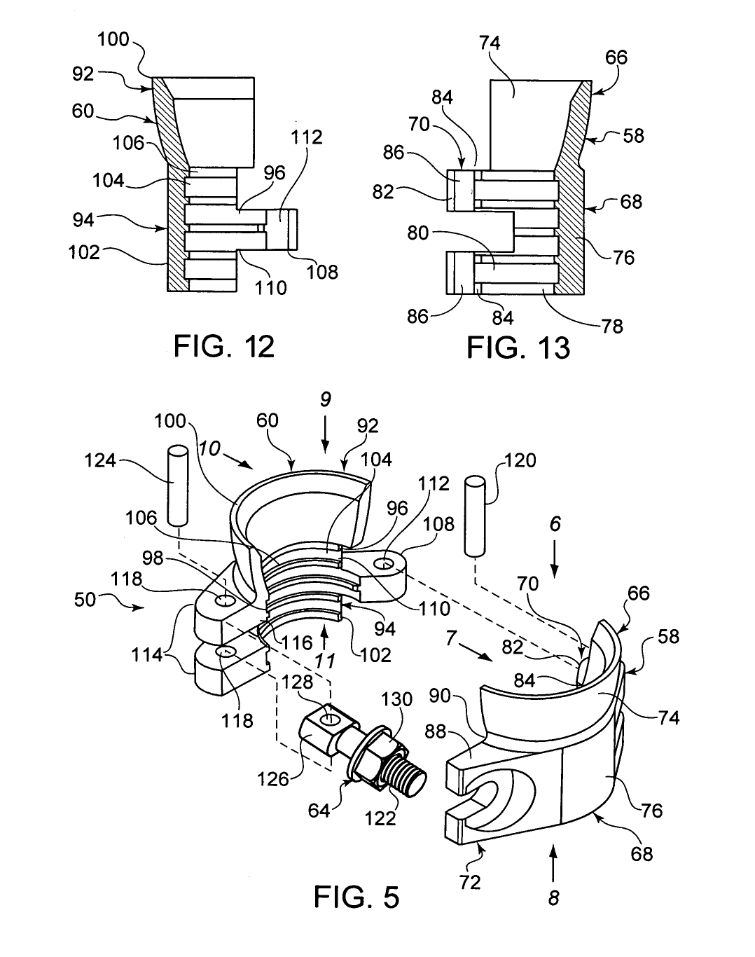

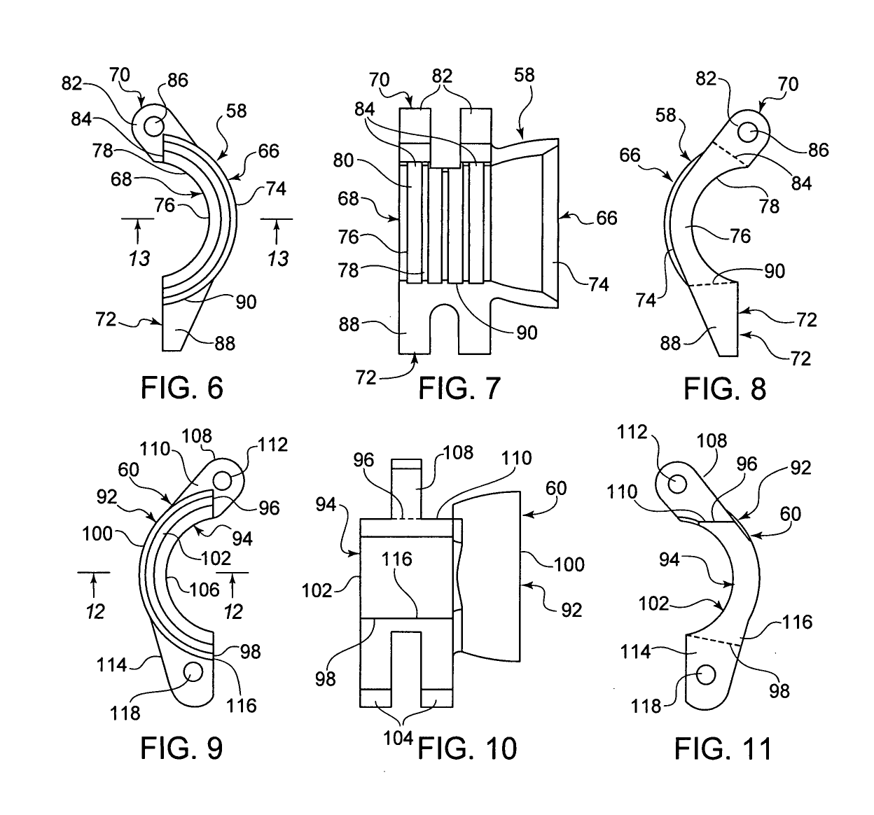

The configuration of the coupler clamp 50 can best be seen in FIGS. 4-13, which are, respectively, an enlarged diagrammatic perspective view of the coupler clamp of the embodiments of the present invention identified by ARROW 4 in FIG. 3 but in the open position, a reduced exploded perspective view of the coupler clamp of the embodiments of the present invention identified by ARROW 5 in FIG. 4, an enlarged diagrammatic top plan view taken generally in the direction of ARROW 6 in FIG. 5, an enlarged diagrammatic side elevational view taken generally in the direction of ARROW 7 in FIG. 5, an enlarged diagrammatic bottom plan view taken generally in the direction of ARROW 8 in FIG. 5, an enlarged diagrammatic top plan view taken generally in the direction of ARROW 9 in FIG. 5, an enlarged diagrammatic side elevational view taken generally in the direction of ARROW 10 in FIG. 5, an enlarged diagrammatic bottom plan view taken generally in the direction of ARROW 11 in FIG. 5, a diagrammatic cross sectional view taken along LINE 12-12 in FIG. 9, and a diagrammatic cross sectional view taken along LINE 13-13 in FIG. 6, and as such, will be discussed with reference thereto.

The coupler clamp 50 comprises a first jaw 58 and a second jaw 60. The first jaw 58 is hinged to the second jaw 60 for allowing the coupler clamp 50 to wrap around the vertical tube 54 of the cup-lock scaffold system 56 and capture an associated flanged end 62 of each of the at least one horizontal tube 52 of the cup-lock scaffold system 56 so as to allow the coupler clamp 50 to detachably attach the at least one horizontal tube 52 of the cup-lock scaffold system 56 to any elevation of the vertical tube 54 of the cup-lock scaffold system 56.

The coupler clamp 50 further comprises a clamping bolt assembly 64. The clamping bolt assembly detachably 50 maintains the closure clamp 50 around the vertical tube 54 of the cup-lock scaffold system 56, while the closure clamp 50 captures the at least one horizontal tube 52 of the cup-lock scaffold system 56.

### (1) First Jaw 58.

The first jaw 58 is generally semi-circular-shaped, and has a base portion 66, a body portion 68, a hinged side portion 70, and a free side portion 72.

The base portion 66 of the first jaw 58 is a semi-cup 74. The semi-cup 74 of the base portion 66 of the first jaw 58 is for receiving a portion of the flanged ends 62 of the at least one horizontal tube 52 of the cup-lock scaffold system 56.

The body portion 68 of the first jaw 58 is a semi-cylinder 76. The semi-cylinder 76 of the body portion 68 of the first jaw 58 extends coaxially from the semi-cup 74 of the base portion 66 of the first jaw 58, and is for bearing upon the vertical tube 54 of the cup-lock scaffold system 56.

The semi-cylinder 76 of the body portion 68 of the first jaw 58 has an interior surface 78. The interior surface 78 of the semi-cylinder 76 of the body portion 68 of the first jaw 58 has semi-circular rings 80 extending outwardly therefrom. The semi-circular rings 80 of the interior surface 78 of the semi-cylinder 76 of the body portion 68 of the first jaw 58 are for improving bearing upon the vertical tube 54 of the cup-lock scaffold system 56.

The hinged side portion 70 of the first jaw 58 comprises a pair of hinge leaf knuckles 82. The pair of hinge leaf knuckles 82 of the hinged side portion 70 of the first jaw 58 are spaced-apart from each other, extend from one side 84 of the semi-cylinder 76 of the body portion 68 of the first jaw 58, and have pivot pin through bores 86, respectively.

The free side portion 72.of the first jaw 58 comprises a catch 88. The catch 88 of the free side portion 72 of the first jaw 58 extends from the other side 90 of the semi-cylinder 76 of the body portion 68 of the first jaw 58.

### (2) Second Jaw 60.

The second jaw 60 is generally semi-circular-shaped, and has a base portion 92, a body portion 94, a hinged side portion 96, and a free side portion 98.

The base portion 92 of the second jaw 60 is a semi-cup 100. The semi-cup 100 of the base portion 92 of the second jaw 60 is for receiving a remaining portion of the flanged ends 62 of the at least one horizontal tube 52 of the cup-lock scaffold system 56.

The body portion 94 of the second jaw 60 is a semi-cylinder 102. The semi-cylinder 102 of the body portion 94 of the second jaw 60 extends coaxially from the semi-cup 100 of the base portion 92 of the second jaw 60, and is for bearing upon the vertical tube 54 of the cup-lock scaffold system 56.

The semi-cylinder 102 of the body portion 94 of the second jaw 60 has an interior surface 104. The interior surface 104 of the semi-cylinder 102 of the body portion 94 of the second jaw 60 has semi-circular rings 106 extending outwardly therefrom. The semi-circular rings 106 of the interior surface 104 of the semi-cylinder 102 of the body portion 94 of the second jaw 60 are for improving bearing upon the vertical tube 54 of the cup-lock scaffold system 56.

The hinged side portion 96 of the second jaw 60 comprises a hinge leaf knuckle 108. The hinge leaf knuckle 108 of the hinged side portion 96 of the second jaw 60 extends from one side 110 of the semi-cylinder 102 of the body portion 94 of the second jaw 60, and has a pivot pin through bore 112.

The free side portion 98.of the second jaw 60 comprises a pair of catches 114. The pair of catches 114 of the free side portion 98 of the second jaw 60 extend from the other side 116 of the semi-cylinder 102 of the body portion 94 of the second jaw 60, and have clamp bolt pin through bores 118, respectively.

The second jaw 60 is hinged to the first jaw 58 by a hinge pin 120. The hinge pin 120 extends in the pivot pin through bore 86 in one hinge leaf knuckle 82 of the hinged side portion 70 of the first jaw 58, in the pivot pin through bore 112 in the hinge leaf knuckle 108 of the hinged side portion 96 of the second jaw 60, and in the pivot pin through bore 86 in the other hinge leaf knuckle 82 of the hinged side portion 70 of the first jaw 58 so as to allow the second jaw 60 and the first jaw 58 to pivot away from each other to receive the vertical tube 54 of the cup-lock scaffold system 56 therebetween, and then the second jaw 60 and the first jaw 58 pivot towards each other around the vertical tube 54 of the cup-lock scaffold system 56 and are maintained thereat by the clamping bolt assembly 64.

### (3) Clamping Bolt Assembly 64.

The clamping bolt assembly 64 is pivotally attached to the second jaw 60, and comprises a bolt 122 and a pivot pin 124. The bolt 122 of the clamping bolt assembly 64 has a head 126 with a through bore 128.

The pivot pin 124 of the clamping bolt assembly 64 extends in the clamp bolt pin through bore 118 in one catch 114 of the free side portion 98 of the second jaw 60, in the through bore 128 in the head 126 of the bolt 122 of the clamping bolt assembly 64, and in the clamp bolt pin through bore 118 in the other catch 114 of the free side portion 98 of the second jaw 60 so as to allow the clamping bolt assembly 64 to pivot relative to the second jaw 60 and be captured in the catch 88 of the free side portion 72 of the first jaw 58 once the second jaw 60 and the first jaw 58 pivot towards each other around the vertical tube 54 of the cup-lock scaffold system 56, and are maintained thereat, by a washer nut 130 threading unto the bolt 122 of the clamping bolt assembly 64, against the catch 88 of the free side portion 72 of the first jaw 58.

### C. Impressions.

It will be understood that each of the elements described above or two or more together may also find a useful application in other types of constructions differing from the types described above.

While the embodiments of the present invention have been illustrated and described as embodied in a coupler clamp for attaching at least one horizontal tube of a cup-lock scaffold system to any elevation of a vertical tube of the cup-lock scaffold system, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A coupler clamp for detachably attaching at least one horizontal tube of a cup-lock scaffold system to any elevation of a vertical tube of the cup-lock scaffold system, comprising:
a) a first jaw; and
b) a second jaw;
wherein said first jaw is hinged to said second jaw for allowing said coupler clamp to wrap around the vertical tube of the cup-lock scaffold system and capture an associated flanged end of each of the at least one horizontal tube of the cup-lock scaffold system so as to allow said coupler clamp to detachably attach the at least one horizontal tube of the cup-lock scaffold system to any elevation of the vertical tube of the cup-lock scaffold system.

2. The clamp of claim 1, further comprising a clamping bolt assembly; and
wherein said clamping bolt assembly detachably maintains said closure clamp around the vertical tube of the cup-lock scaffold system, while said closure clamp captures the at least one horizontal tube of the cup-lock scaffold system.

3. The clamp of claim 2, wherein said first jaw is generally semi-circular-shaped;
wherein said first jaw has a base portion;
wherein said first jaw has a body portion;
wherein said first jaw has a hinged side portion; and
wherein said first jaw has a free side portion.

4. The clamp of claim 3, wherein said base portion of said first jaw is a semi-cup; and
wherein said semi-cup of said base portion of said first jaw is for receiving a portion of the flanged ends of the at least one horizontal tube of the cup-lock scaffold system.

5. The clamp of claim 4, wherein said body portion of said first jaw is a semi-cylinder;
wherein said semi-cylinder of said body portion of said first jaw extends coaxially from said semi-cup of said base portion of said first jaw; and
wherein said semi-cylinder of said body portion of said first jaw is for bearing upon the vertical tube of the cup-lock scaffold system.

6. The clamp of claim 5, wherein said semi-cylinder of said body portion of said first jaw has an interior surface;
wherein said interior surface of said semi-cylinder of said body portion of said first jaw has semi-circular rings extending outwardly therefrom; and
wherein said semi-circular rings of said interior surface of said semi-cylinder of said body portion of said first jaw is for improving bearing upon the vertical tube of the cup-lock scaffold system.

7. The clamp of claim 3, wherein said hinged side portion of said first jaw comprises a pair of hinge leaf knuckles;
wherein said pair of hinge leaf knuckles of said hinged side portion of said first jaw are spaced-apart from each other;
wherein said pair of hinge leaf knuckles of said hinged side portion of said first jaw extend from one side of said semi-cylinder of said body portion of said first jaw; and
wherein said pair of hinge leaf knuckles of said hinged side portion of said first jaw have pivot pin through bores, respectively.

8. The clamp of claim 7, wherein said free side portion of said first jaw comprises a catch; and
wherein said catch of said free side portion of said first jaw extends from the other side of said semi-cylinder of said body portion of said first jaw.

9. The clamp of claim 7, wherein said second jaw is generally semi-circular-shaped;
wherein said second jaw has a base portion;
wherein said second jaw has a body portion;
wherein said second jaw has a hinged side portion; and
wherein said second jaw has a free side portion.

10. The clamp of claim 9, wherein said base portion of said second jaw is a semi-cup; and
wherein said semi-cup of said base portion of said second jaw is for receiving a remaining portion of the flanged ends of the at least one horizontal tube of the cup-lock scaffold system.

11. The clamp of claim 10, wherein said body portion of said second jaw is a semi-cylinder;
wherein said semi-cylinder of said body portion of said second jaw extends coaxially from said semi-cup of said base portion of said second jaw ; and
wherein said semi-cylinder of said body portion of said second jaw is for bearing upon the vertical tube of the cup-lock scaffold system.

12. The clamp of claim 11, wherein said semi-cylinder of said body portion of said second jaw has an interior surface;
wherein said interior surface of said semi-cylinder of said body portion of said second jaw has semi-circular rings extending outwardly therefrom; and
wherein said semi-circular rings of said interior surface of said semi-cylinder of said body portion of said second jaw is for improving bearing upon the vertical tube of the cup-lock scaffold system.

13. The clamp of claim 9, wherein said hinged side portion of said second jaw comprises a hinge leaf knuckle;
wherein said hinge leaf knuckle of said hinged side portion of said second jaw extends from one side of said semi-cylinder of said body portion of said second jaw; and
wherein said hinge leaf knuckle of said hinged side portion of said second jaw has a pivot pin through bore.

14. The clamp of claim 13, wherein said free side portion of said second jaw comprises a pair of catches;
wherein said pair of catches of said free side portion of said second jaw extend from the other side of said semi-cylinder of said body portion of said second jaw; and
wherein said pair of catches of said free side portion of said second jaw have clamp bolt pin through bores, respectively.

15. The clamp of claim 13, wherein said second jaw is hinged to said first jaw by a hinge pin; and
wherein said hinge pin extends in the pivot pin through bore of one hinge leaf knuckle of said hinged side portion of said first jaw, in said pivot pin through bore in said hinge leaf knuckle of said hinged side portion of said second jaw, and in the pivot pin through bore of the other hinge leaf knuckle of said hinged side portion of said first jaw so as to allow said second jaw and said first jaw to pivot away from each other to receive the vertical tube of the cup-lock scaffold system therebetween, and then said second jaw and said first jaw pivot towards each other around the vertical tube of the cup-lock scaffold system, and are maintained thereat, by said clamping bolt assembly.

16. The clamp of claim 14, wherein said clamping bolt assembly is pivotally attached to said second jaw;
wherein said clamping bolt assembly comprises a bolt;
wherein said clamping bolt assembly comprises a pivot pin;
wherein said bolt of said clamping bolt assembly has a head; and
wherein said head of said bolt of said clamping bolt assembly has a through bore.

17. The clamp of claim 16, wherein said pivot pin of said clamping bolt assembly extends in said clamp bolt pin through bore of one catch of said free side portion of said second jaw, in said through bore in said head of said bolt of said clamping bolt assembly, and in said clamp bolt pin through bore of the other catch of said free side portion of said second jaw so as to allow said clamping bolt to pivot relative to said second jaw and be captured in said catch of said free side portion of said first jaw when said second jaw and said first jaw pivot towards each other around the vertical tube of the cup-lock scaffold system, and are maintained thereat, by a washer nut threading unto said bolt of said clamping bolt assembly, against said catch of said free side portion of said first jaw.
